(19) United States
(12) Patent Application Publication
(10) Pub. No.: US 2003/0133136 A1
(43) Pub. Date: Jul. 17, 2003

(54) Method for generating and launching application for information processing apparatus and image forming apparatus

(76) Inventors: Tsutomu Ohishi, Fukuoka (JP); Katsuhiko Nakagawa, Fukuoka (JP); Hiroyuki Tanaka, Fukuoka (JP); Yuuko Sugiura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/327,938

(22) Filed: Dec. 26, 2002

(30) Foreign Application Priority Data
Dec. 27, 2001 (JP) 2001-398280
Dec. 18, 2002 (JP) 2002-367045
Dec. 18, 2002 (JP) 2002-367046

(51) Int. Cl. B41J 1/00

(52) U.S. Cl. 358/1.1

(57) ABSTRACT

An application development kit includes a control service executable file and a control service function library including service functions, which are installed in a HD 130 of the development server 100. A compiler 110 compiles a new application source file 132 so as to generate an object file 133 A linker 120 links the object file 133 with the control service function library so as to generate an application executable file 134. Then, the application executable file 134 and the control service executable file are stored in a launching flashcard 407 of a compound machine 300.

### BACKGROUND OF THE INVENTION

1. Field of the Invention

The present invention relates to technologies for developing applications used in an information processing apparatus including hardware resources and applications for providing user services that uses the hardware resources. More particularly, the present invention relates to technologies for developing applications used in an image forming apparatus that provides user services on image forming such as copying, printing, scanning and sending a facsimile.

2. Description of the Related Art

Recently, an information processing apparatus that includes or connects various hardware resources and that provides user services by using the hardware resources becomes widespread. For example, as an example of the information processing apparatus, an image forming apparatus (to be referred to as a compound machine hereinafter) that includes functions of a printer, a copier, a facsimile, a scanner and the like in a cabinet is generally known. The compound machine includes a display part, a printing part and an image pickup part and the like in a cabinet. In the compound machine, four pieces of software corresponding to the printer, copier, scanner and facsimile respectively are provided, so that the compound machine functions as the printer, the copier, the scanner and the facsimile respectively by switching the software.

Since the conventional compound machine is provided with each software for the printer, the copier, the scanner and the facsimile individually, much time is required for developing the software. Therefore, the applicant has developed an image forming apparatus (compound machine) including hardware resources, a plurality of applications, and a platform including various control services provided between the applications and the hardware resources. The hardware resources are used for image forming processes for a display part, a printing part and an image pickup part. The applications perform processes intrinsic for user services of printer, copier and facsimile and the like. The platform includes various control services performing management of hardware resources necessary for at least two applications commonly, execution control of the applications, and image forming processes, when a user service is executed.

Since the image forming apparatus includes the platform that performs management of hardware resources used by at least two applications commonly, and that performs execution control and image forming processes, software can be developed efficiently, so that productivity for the machine can be improved.

According to such a new compound machine, the applications and the control services are provided separately. Thus, after the compound machine is shipped, users or third party venders can develop new applications to install on the compound machine. By doing so, various functions can be provided.

Therefore, a new problem arises in that it is necessary to develop a new application efficiently and to perform debugging for efficiently and accurately verifying the application that operates on the image forming apparatus on which many processes run. This problem is common to information processing apparatuses having a configuration similar to that of the image forming apparatus.

### SUMMARY OF THE INVENTION

An object of the present invention is to develop a new application efficiently and performing debugging for efficiently and accurately verifying the application that operates on the image forming apparatus or on the information processing apparatus on which many processes runs.

The above object is achieved by a method for generating a new application used in an image forming apparatus, the image forming apparatus comprising hardware resources used for image formation, an application for performing processes on image formation, and a control service that exists between the application and the hardware resources, wherein interprocess communication is performed between the control service and the new application, the method including;

a compile step of compiling a source file in which source code of the new application is described so as to generate an object file; and

a link step of linking the object file with a service function library that includes service functions provided by the control service so as to generate an executable program of the new application.

According to this method, the new application can be developed efficiently.

The above object is also achieved by a method for launching a new application used in an image forming apparatus, the image forming apparatus comprising hardware resources used for image formation, an application for performing processes on image formation, and a control service that exists between the application and the hardware resources, wherein interprocess communication is performed between the control service and the new application, the method comprising:

a step of reading an executable program of the new application from a launching recording medium that stores the executable program, and launching the executable program in the image forming apparatus; and

a step of reading an executable program of the control service from a memory in the image forming apparatus that stores the executable program of the control service, and launching the executable program of the control service in the image forming apparatus, at the time when the image forming apparatus is launched.

According to this method, since the new application is launched from the launching recording medium, debugging of the new application can be performed efficiently. In addition, a new application can be provided to users speedily.

The above object is also achieved by a method for launching a new application used in an image forming apparatus, the image forming apparatus comprising hardware resources used for image formation, an application for performing processes on image formation, and a control service that exists between the application and the hardware resources, wherein interprocess communication is performed between the control service and the new application, the method comprising:

a connecting step of mounting a file system on a network storing an executable program of the new application to a file system in the image forming apparatus via the network at the time when the image forming apparatus is launched; and

an application launching step of launching the new application from the file system on the network.

According to this method, it is not necessary to store a developed new application in a launching recording medium. Thus, after generating the new application, debugging of the new application can be performed efficiently. In addition, the new application can be launched from a remote server.

The above-mentioned methods can be applied to a new application used in an information processing apparatus that includes hardware resources, an application for providing a user service by using the hardware resources, and a control service that exists between the application and the hardware resources, wherein interprocess communication is performed between the control service and the new application.

### BRIEF DESCRIPTION OF THE DRAWINGS

Other objects, features and advantages of the present invention will become more apparent from the following detailed description when read in conjunction with the accompanying drawings, in which:

FIG. 1 is a software block diagram of a development server according to a first embodiment of the present invention;

FIG. 2 is a block diagram showing a hardware configuration of the development server and a development PC, and a development environment according to a first embodiment of the present invention;

FIG. 3 is a block diagram showing a functional configuration of the compound machine according to a first embodiment of the present invention;

FIG. 4 shows a hardware configuration of the compound machine according to the first embodiment of the present invention;

FIG. 5 shows an example of a software configuration of an information processing apparatus according to an embodiment of the present invention;

FIG. 6 shows a relationship between a new application 317 and a control service with respect to function call;

FIG. 7 shows a flowchart showing a procedure for generating a new application by the development server according to the first embodiment of the present invention;

FIG. 8 is an example of a data structure showing content of data in the flashcard 407 according to the first embodiment of the present invention;

FIG. 9 is another example of a data structure showing content of data in the flashcard 407 according to the first embodiment of the present invention;

FIG. 10 is still another example of a data structure showing content of data in the flashcard 407 according to the first embodiment of the present invention;

FIG. 11 shows a block diagram showing the configuration of a compound machine initializing part that is executed when the compound machine is launched;

FIG. 12 shows a flowchart showing a procedure of initialization in the case when the compound machine in which the flashcard is inserted launches;

FIG. 13 is a block diagram showing a network configuration and a debugging environment including a development server 100, a development PC 200, a network server 1000 and the compound machine 300 according to a second embodiment of the present invention;

FIG. 14 is a flowchart showing a procedure for initialization at the time of network boot of the compound machine 300 according to the second embodiment of the present invention;

FIG. 15 is a figure for explaining files stored in a HD 130 of the development server 100 according to the third embodiment of the present invention;

FIG. 16 shows a block diagram showing another example of the development environment and the debugging environment;

FIG. 17 shows a block diagram showing another example of the development environment and the debugging environment.

### DETAILED DESCRIPTION OF THE PREFERRED EMBODIMENTS

In the following, preferred embodiments of the present invention will be described with reference to figures.

(First Embodiment)

According to the first embodiment, for developing a new application that runs on an image forming apparatus (to be referred to as a compound machine hereinafter), an application source file is prepared by using a development PC (personal computer). Then, an application development kit is installed in a development server, wherein the application development kit is provided by means of a recording medium such as a CD-ROM. The application source file is compiled and linked, so that an executable file of the application that is executable on the compound machine is generated.

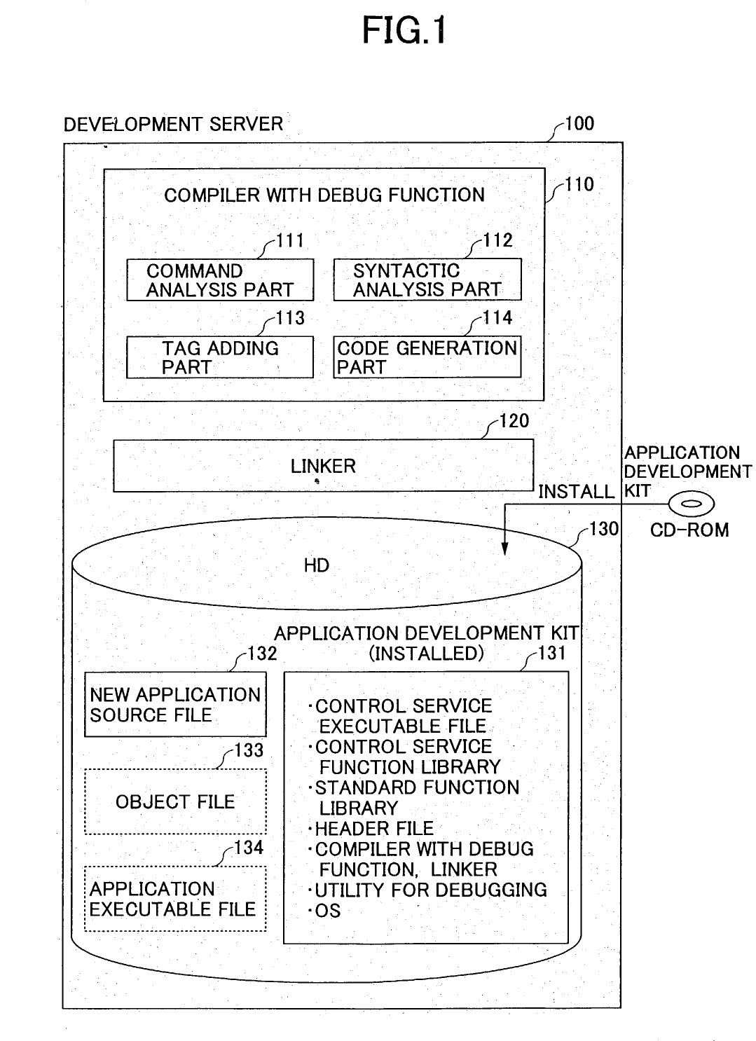

FIG. 1 shows a block diagram showing a software configuration of the development server 100 according to the first embodiment of the present invention. FIG. 1 shows a state in which the application development kit is installed on a hard disk (HD) 130 of the application development kit. The development server 100 of the first embodiment compiles and links the new application source file to generate an executable program to be executed on the compound machine. As shown in FIG. 1, the development server 100 includes a compiler 110 with a debugging function and a linker 120.

The compiler 110 with debugging function generates an object file including object code from a new application source file 132 according to instructions of commands, wherein the new application source file 132 is stored in the hard disk (HD) 130 and includes source code of the application. As shown in FIG. 1, the compiler 110 with debugging function includes a command analysis part 111, a syntactic analysis part 112, a tag adding part 113, and a code generation part 114.

The application development kit 131 is installed on the HD 130. In addition, the HD 130 stores the new application source file 132 in which C language source code of the application is described. The new application source file 132 is prepared on the development PC by using an editor, and is copied to the development server 100. In addition, in the HD 130, the object file 133 is generated by the compiler 110 with debugging function, and the application executable file 134 is generated by the linker 120.

The command analysis part 111 analyzes parameters and syntax of a command input from an input device such as a keyboard by a user so as to determine whether the command is grammatical.

The syntax analysis part 112 receives the new application source file 132, analyzes the C language source code of the new application source file 132 according to the C language grammar, so as to generate a derivation tree or a syntactic tree. The syntax analysis part 112 performs the same process as that of a general compiler.

The tag adding part 113 adds tags, which are verifying code for debugging, to an entrance and an exit of a function in the new application source file 132. The code generation part 114 generates the object file 133 from the new application source file 132 in which syntax analysis is performed and the verification code are added as necessary. The linker 120 links the object file 133 with a control service function library and a standard function library in the application development kit 131 so as to generate the application executable file 134 that is executable on the compound machine 300 and on an OS of a computer.

The application development kit 131 is provided by a recording medium such as a CD-ROM or a flexible disk (FD). The application development kit 131 can be installed to a computer from the recording medium. The application development kit 131 is installed on the HD 130 of the development server 100 As shown in FIG. 1, the application development kit 131 includes executable files of control services such as ECS 324 and MCS 325, a control service function library for each control service (for example, ECS function library, MCS function library), a standard function library including C language standard functions such as strcpy and memcpy, a header file including function declarations and message declarations commonly used for the applications and the control services, a program for the compiler 110, a program of the linker 120, a general OS program and utilities for debugging such as a debugger.

When the application development kit 131 is launched, each part of the compiler 110 with debugging function, and the linker 120 are loaded on a RAM 203 and are executed. Although the application development kit is provided by the recording medium, the executable file or a file that can be installed can be downloaded via a network.

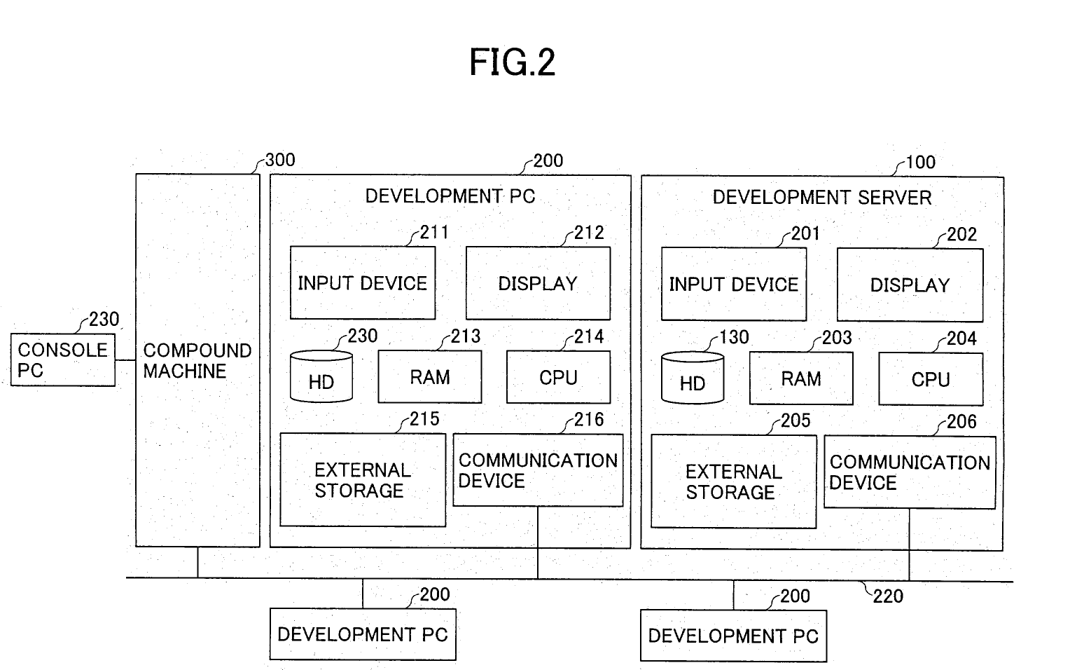

FIG. 2 is a block diagram showing a hardware configuration of the development server and the development PC, and the development environment. As shown in FIG. 2, the development server 100 includes a control device 204 such as CPU, a RAM (Random Access Memory) 203, a HD 130, a display 202, an input device 201 such as a keyboard and a mouse, a communication device 206 such a LAN board and a modem, and an external storing device 205 such as a flashcard interface for controlling read and write of a flashcard and a CD drive device for reading CD-ROM. The development server is a normal computer such as a PC and a workstation.

The development server 100 is connected to the development PC 200 and the compound machine 300 via a network such as Ethernet 220, in which a LAN environment is formed. As shown in FIG. 2, the hardware configuration of the development PC 200 is the same as that of the development server 100. A console PC 230 is connected to the compound machine 300 by a cable for controlling launch of the compound machine and for displaying and error.

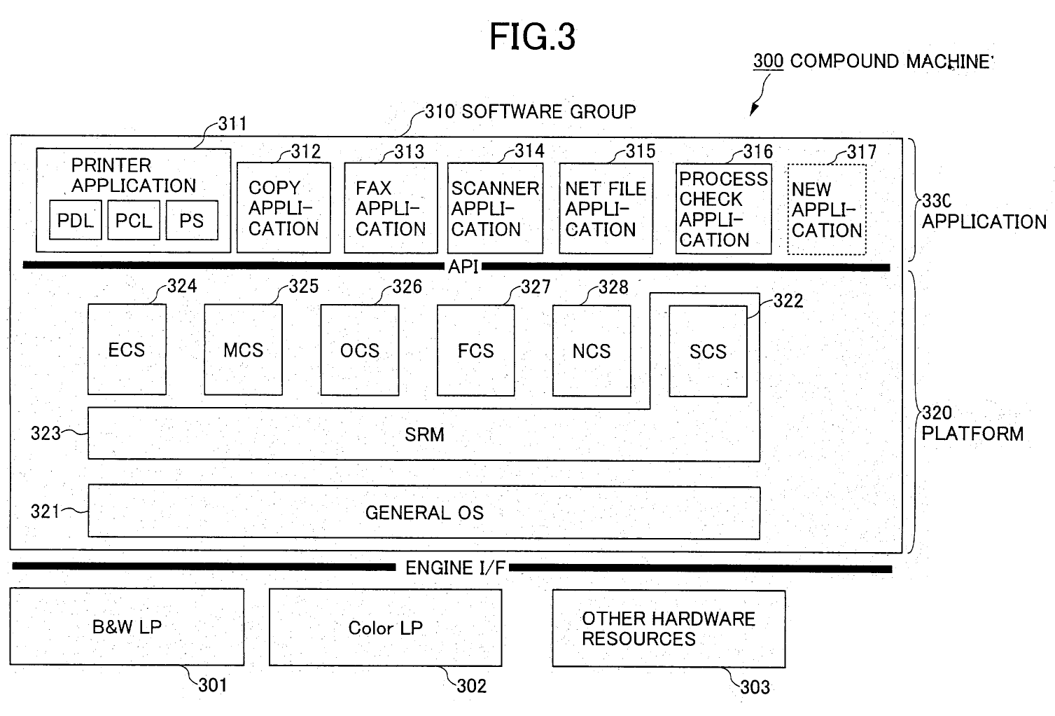

Next, the compound machine 300 in which the new application is to be loaded will be described. FIG. 3 is a block diagram showing a functional configuration of the compound machine 300. As shown in FIG. 3, the compound machine 300 includes a black and white line printer (B&W LP) 301, a color line printer 302, and hardware resources 303 and a software group 310. The hardware resources 303 include a scanner, a facsimile, a hard disk and a network interface and the like. The software group 310 includes a platform 320 and applications 330.

The platform 320 includes control services for interpreting a processing request from an application to issue an acquiring request for hardware resources, a system resource manager (SRM) 323 for managing one or more hardware resources and arbitrating acquiring requests from the control services, and a general-purpose OS 321.

The control services include a plurality of service modules including a system control service (SCS) 322, an engine control service (ECS) 324, a memory control service (MCS) 325, a fax control service (FCS) 327, and a network control service (NCS) 328. In addition, the platform 320 has application program interfaces (API) that can receive process requests from the applications 330 by using predetermined functions.

The general purpose OS 321 is a general purpose operating system such as UNIX, and can execute each piece of software of the platform 320 and the applications 330 concurrently as processes.

The process of the SRM 323 is for performing control of the system and performing management of resources with the SCS 322. The process of the SRM 323 performs arbitration and execution control for requests from the upper layer that uses hardware resources including engines such as the scanner part and the printer part, a memory, a HDD file, a host I/Os (Centronics I/F, network I/F IEEE1394 I/F, RS232C I/F and the like).

Specifically, the SRM 323 determines whether the requested hardware resource is available (whether it is not used by another request). When the requested hardware resource is available, the SRM 323 notifies the upper layer that the requested hardware resource is available. In addition, the SRM 323 performs scheduling for using hardware resources for the requests from the upper layer, and directly performs processes corresponding to the requests (for example, paper transfer and image forming by a printer engine, allocating memory area, file generation and the like).

The process of the SCS 322 performs application management, control of the operation part, display of system screen, LED display, resource management, and interrupt application control. The process of the ECS 324 control hardware resources including the white and black line printer (B&W LP) 301, the color line printer (Color LP),302, the scanner, and the facsimile. The process of the MCS 325 obtains and releases an area of the image memory, uses the hard disk apparatus (HDD), and compresses and expands image data.

The process of the FCS 327 provides APIs for sending and receiving of a facsimile from each application layer of the system controller by using a PSTN/ISDN network, for registering/referring of various kinds of facsimile data managed by BKM (backup SRAM), for facsimile reading, for facsimile receiving and printing, and for mixed sending and receiving.

The process of NCS 328 is a process for providing services commonly used for applications that need the network I/O. The NCS 328 distributes data received from the network by each protocol to a corresponding application, and acts as mediation between the application and the network when sending data to the network. Specifically, the process of the NCS 328 includes server daemons such as ftpd, httpd, lpd, snmpd, telnetd, and smtpd. In addition, the process of the NCS 328 includes client functions of the protocols.

The OCS 326 controls an operation panel 410 that is a means for transferring information between the operator (user) and control parts of the machine. In the compound machine 300 of the embodiment, the OCS 326 includes an OCS process part and an OCS function library part. The OCS process part obtains an key event, which indicates that the key is pushed, from the operation panel 410, and sends a key event function corresponding to the key event to the SCS 322. The OCS function library registers drawing functions and other functions for controlling the operation panel, in which the drawing functions are used for outputting various images on the operation panel on the basis of a request from an application that has control right or from the control service. When the application 330 is developed, functions in the OCS function library is linked to an object program that is generated by compiling a source code file of the application 330, so that an executable file of the application 330 is generated.

Although-the OCS 326 is formed by the part executed by processes and the OCS function library in the compound machine 300 of the embodiment, the OCS 326 can be configured such that the whole of the OCS 326 operates as processes, or such that the whole of the OCS 126 is formed by the OCS function library.

The application 330 includes a printer application 311 that is an application for a printer having page description language (PDL), PCL and post script (PS), a copy application 312, a fax application 313 that is an application for facsimile, a scanner application 314 that is an application for a scanner, a network file application 315 and a process check application 316. Each of the applications 330 is launched as a process by an initializing part (not shown in the figure) when the compound machine 300 is launched.

Interprocess communication is performed between a process of the application 330 and a process of the control service, in which a function is called, a return value is sent, and a message is sent and received. By using the interprocess communication, user services for image forming processes such as copying, printing, scanning, and sending facsimile are realized.

As mentioned above, the compound machine 300 of the first embodiment includes a plurality of applications 330 and a plurality of control services, and each of those operates as a process. In each process, one or more threads are generated and the threads are executed in parallel. The control services provide common services to the applications 330. User services on image formation such as copying, printing, scanning and sending facsimile are provided while the processes are executed in parallel, the threads are executed in parallel, and interprocess communication is performed. A third party vendor can develop an application (new application 317) for the compound machine 300, and can executes the application in an application layer on the control service layer in the compound machine 300.

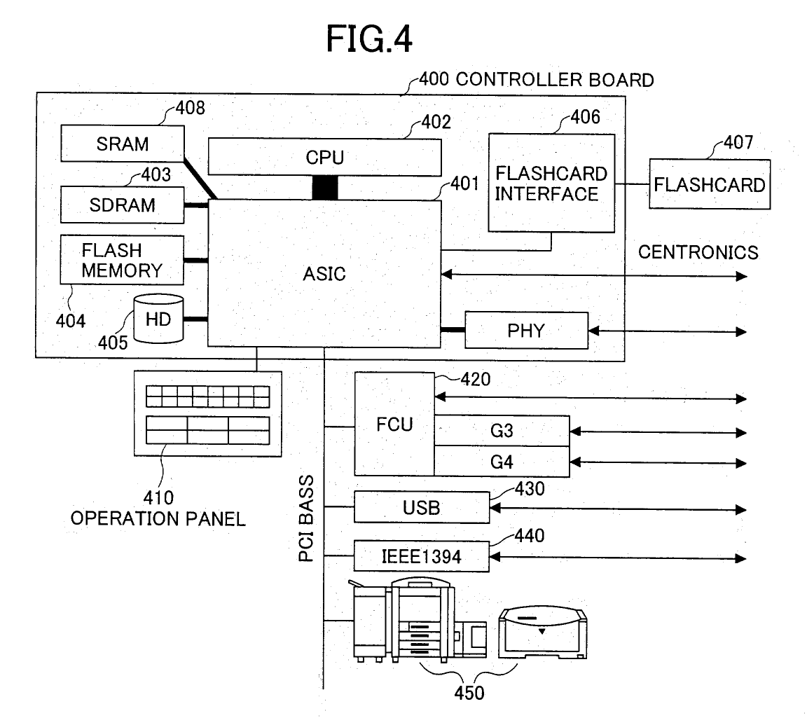

FIG. 4 shows a hardware configuration of the compound machine 300 according to the first embodiment. As shown in FIG. 4, the compound machine 300 includes a controller board 400, an operation panel 410, a fax control unit (FCU) 420, a USB 430, an IEEE1394 440, and a printer 450. The controller board 400 includes a CPU 402, a SDRAM 403, a SRAM 408, a flash memory (flash ROM) 404, a flash card interface,part 406 and a HD 405 that are connected to the ASIC 401. The operation panel 410 is directly connected to the ASIC 401. The FCU 420, the USB 430, the IEEE1394 440 and the printer 450 are connected to the ASIC 401 via the PCI bus.

A flashcard 407 is inserted into a flash card interface part 406, so that data is sent/received between the compound machine 300 and the flashcard 407 via the flash card interface part 406. The flashcard 407 stores billing information of the user and the like.

The operation panel 410 includes an operation part used for key operation such as key input and button pushing and the like by the user, and an display part for displaying drawing data such as button, window and various screens.

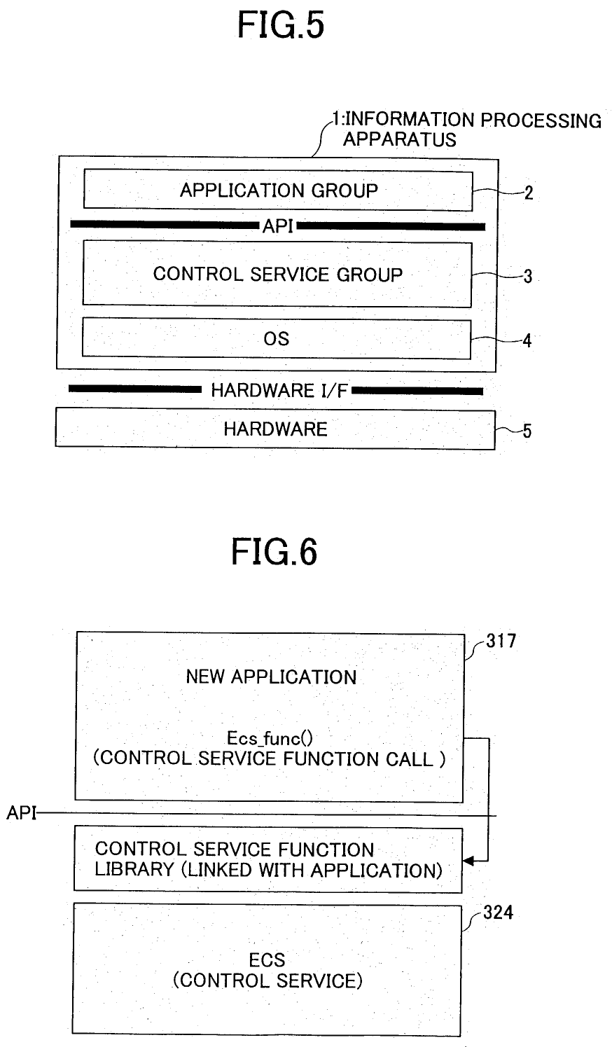

It is easy to replace the printer part 450 with other hardware in the image forming apparatus in FIG. 4. By replacing the printer part 450 with other hardware, the structure of FIG. 4 becomes an example of a general information processing apparatus that provides user services by using the hardware. In this case, in the software configuration of FIG. 3, control services and applications are used according to functions of the hardware. An example of a software configuration of the information processing apparatus is shown in FIG. 5. In the same way as the configuration of FIG. 3, the configuration of FIG. 5 includes an application group 2, a control service group 3, OS 4, and hardware resources 5.

FIG. 6 shows a relationship between the new application 317 and a control service with respect to function call. As shown in FIG. 6, interprocess communication is performed between a process of the new application 317 and a process of the control service (ECS 324), a function called in the control service side is executed. More particularly, the process of the new application 317 calls a function (Ecs_func) provided by the control service by using APT (application program interface). Then, the called function is executed in the control service side. That is, substance of the service function exists in the control service side. The service function is registered in a control service function library (ECS function library in FIG. 6). The control service function library is linked to the new application 317 that is the calling side. The application development kit 131 provides the control service function library and control service executable files (executable programs).

In the following, a generation method of a new application by using the development server 100, a development PC 200 and an application development kit 131 according to the first embodiment will be described.

First, a user writes source code of the new application 317 by using an editing tool such as an editor on the development PC 200 so as to generate a source file. Any function can be implemented in the new application 317. For example, following functions may be a part of or whole of the functions of the new application 317: displaying screens on the operation panel 410, storing data read by a scanner in a file, processing and editing of image data, printing by using a plotter, notification request and notification of machine state, and, connecting to other apparatuses by using the Ethernet. Such new application 317 can be generated by using the application development kit 131. When the general OS 321 of the compound machine 300 is UNIX, the new application 317 may be software for UNIX. The function of the new application 317 is not limited to those mentioned above.

Then, the new application source file is stored in the HD 130 in the development server 100 via a network. Then, the user inputs a launching command of the compiler with debugging function and a linker from the input device 211 such as a keyboard of the development server 100 in order to generate an executable file of the new application 317.

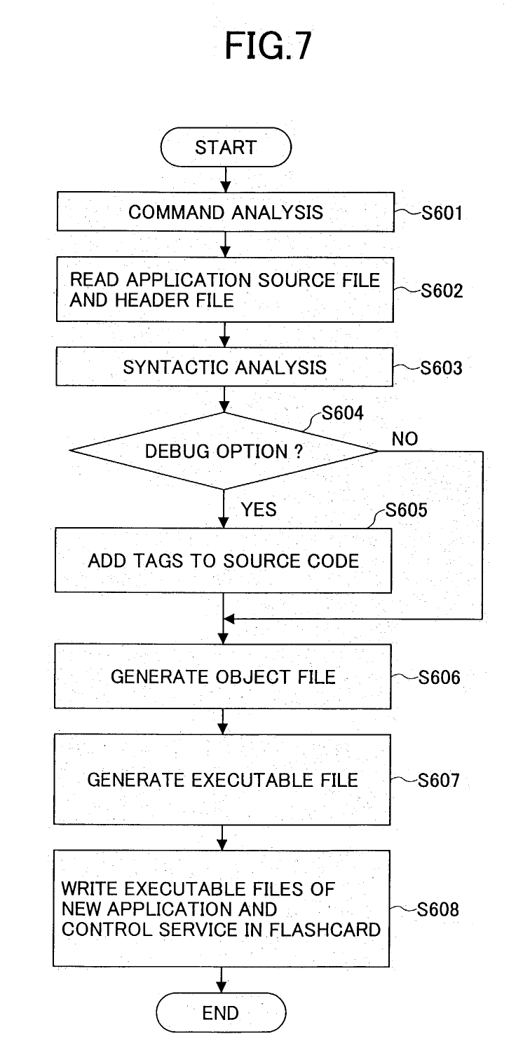

FIG. 7 shows a flowchart showing a procedure for generating an executable file of a new application by the development server 100. When a launching command is input, the compiler 110 with debugging function is launched, and the command analysis part 111 in the compiler 110 analyzes the input command in step S601. More specifically, the command analysis part 111 analyzes parameters and syntax so as to determine whether the input command is grammatical.

Next, the syntax analysis part 112 reads the new application source file 132 and the header file in the installed application development kit 131 in step S602. Then, the syntax analysis part 112 performs syntactic analysis of C language source code in the new application source file 132 in step S603. More specifically, the syntax analysis part 112 analyses the C language source code according to C language grammar to generate a derivation tree and a syntax tree and the like.

Then, the command analysis part 111 checks whether a debug option is set in the input launching command in step S604. If the debug option is set, tags as verification code are added, for example, at the entrance and at the exit of an function in step S605. The tag is used for debugging printf clause, assert clause and the like, in which a variable, an argument of a function and a return value of a function are output. If the debug option is not specified, the process for adding the tag is not performed, and a normal compile process is performed.

Next, the code generation part 114 performs a code generation process so as to generate object code of the new application 317, and stores the object code in the HD 130 as the object file 133 in step S606. Then, the object file 133 is linked with the control service function library and the standard function library of the application development kit 131, so that the application executable file 134 is generated in step S607. Then, the application executable file 134 is written in a flashcard with all control service executable files of the application development kit 131 in step S608. For writing the files into the flashcard 407, a card writing command may be prepared as a script such as a make file with a launching command of the compiler 110 and the linker 120, so that the processes from compiling to writing into the flashcard 407 can be performed automatically. In addition, the user may input each command manually.

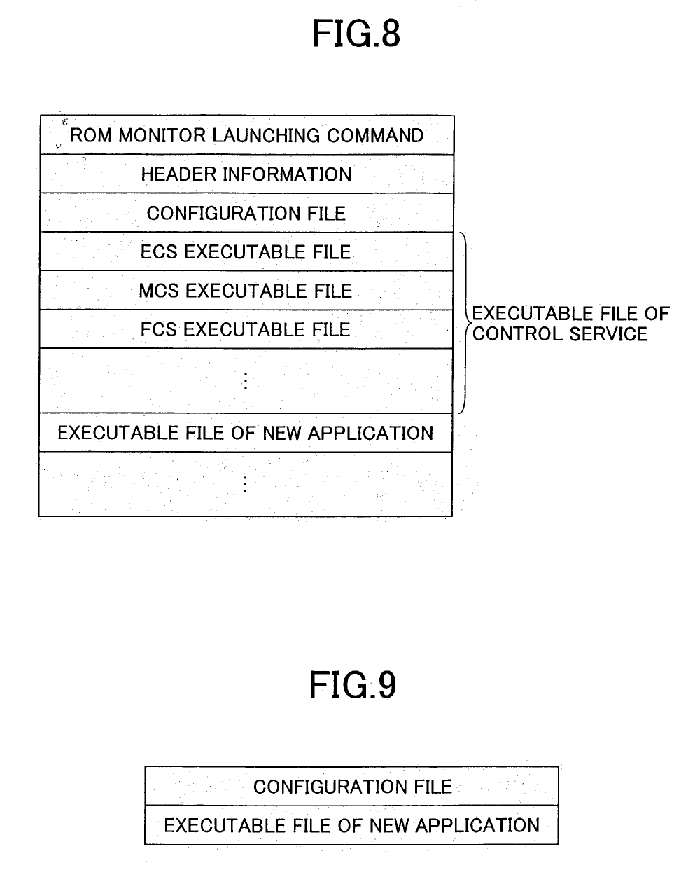

FIG. 8 shows a data structure showing content of data in the flashcard 407. According to designation by the user, the flashcard 407 stores ROM monitor launching command at the head, and stores header information, configuration file, control service executable files such as ECS executable file and MCS executable file, and application executable file 134 of the new application 317.

The ROM monitor launching command is a command for launching after-mentioned ROM monitor. This command is referred to when the compound machine 300 is launched. The header information includes offsets from the head address for the configuration file and the control service executable files, and includes the data length and the like. The configuration file is referred to when the compound machine 300 is launched. The configuration file specifies control services and applications to be executed by the compound machine 300. The configuration file is prepared by the user on the development server 100. Each files are written in the flashcard 407 with each control service executable file and application executable file in step S608 by the card writing command.

In the example shown in FIG. 8, the executable file of the new application and executable files of the control services are stored in the flashcard 407. However, information to be stored in the flashcard 407 is not limited to the example of FIG. 8.

For example, as shown in FIG. 9, the flashcard 407 may stores only the configuration file and the executable file of the new application. In this case, other data or program necessary for launching of the compound machine is stored in a ROM in the compound machine beforehand. Then, the new application is launched from the flashcard 407 and each control service is launched from the ROM.

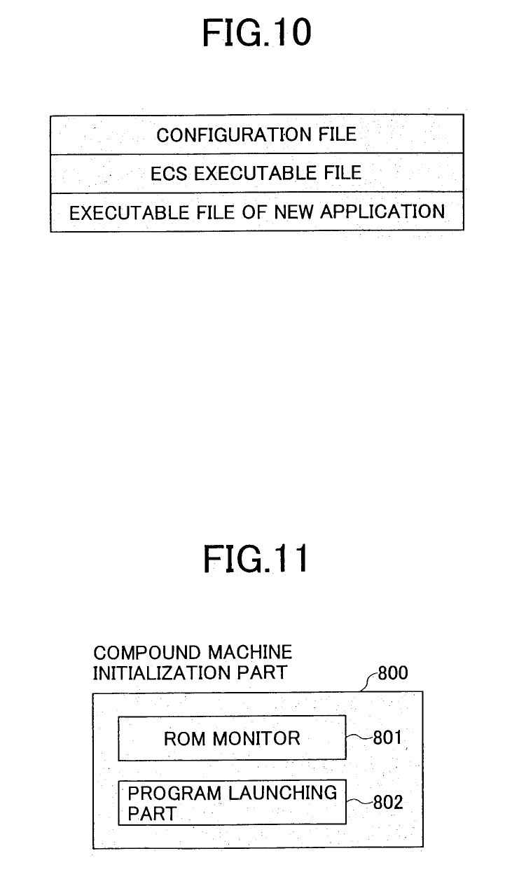

In addition, as shown in FIG. 10, the flashcard 407 may store an executable file of a specific control service and the executable file of the new application. This example can be applied to a case, for example, where the specific control service (ECS executable file in the example of FIG. 10) is customized according to a demand of a user. Also in this case, other data or program necessary for launching of the compound machine is stored in a ROM in the compound machine beforehand.

Further, a recording medium (not limited to the flashcard 407) may store only the executable file of the new application, such that the executable file of the new application can be installed in the HD 405 of the compound machine 300 from the recording medium (referred to as installing recording medium), and the new application is launched form the HD 405. In addition, the recording medium may store only the executable files of the new application and the specific control service, such that the executable files are installed in the HD 405 of the compound machine 300, and the new application and the specific control service are launched from the HD 405.

Next, a method for debugging the new application 317 generated in the above-mentioned way will be described. This method corresponds to a case where the flashcard 407 stores files shown in FIG. 8.

A user who performs debugging inserts the flashcard 407 into the flashcard interface part 406 of the compound machine 300, and turns on the compound machine 300 so as to launch the compound machine 300, in which the flashcard 407 includes the new application 317 (application executable file 134) and the control services (executable files).

FIG. 11 shows a block diagram showing the configuration of a compound machine initializing part 800 that is executed when the compound machine 300 is launched. The compound machine 800 includes a ROM monitor 801 and a program launching part 802. The ROM monitor 801 is launched by executing the ROM monitor launching command stored in the head of the flashcard 407. The ROM monitor 801 initializes hardware, diagnoses the controller board, initializes software and launches the general OS 321.

The program launching part 802 is called from the general OS 321. The program launching part 802 refers to the configuration file in the flashcard 407, reads control services and applications specified by the configuration file from the flashcard so as to launching the control services and applications.

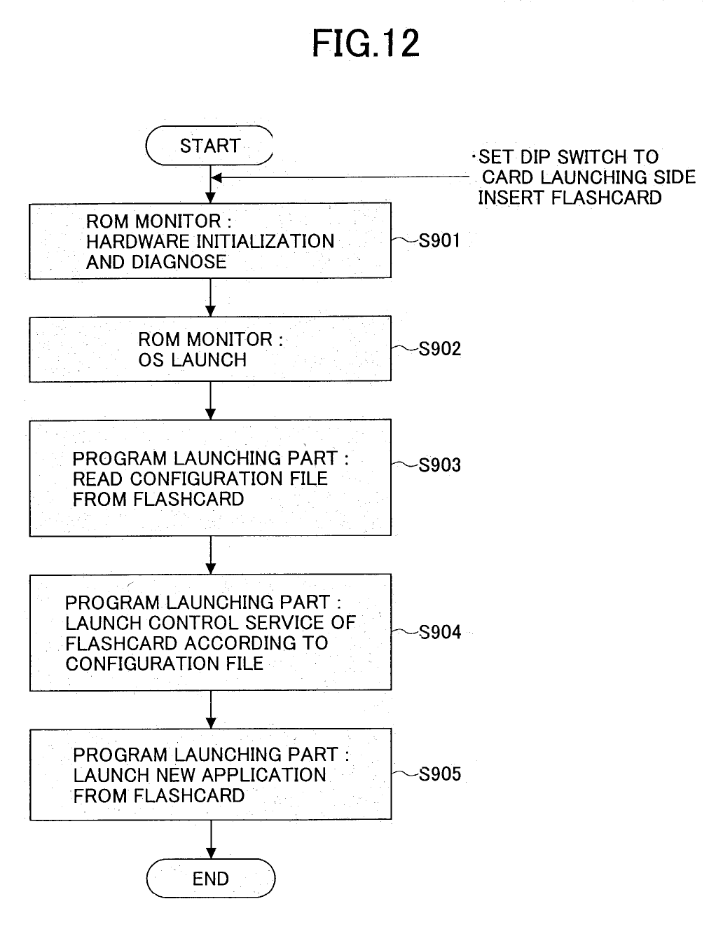

FIG. 12 shows a flowchart showing a procedure for initialization in the case where the compound machine 300 launches while the flashcard 407 is inserted. First, the user sets a DIP switch at a position for launching from the flashcard 407, inserts the flashcard 407 into the flashcard interface part 406, and turns on the compound machine 300. In the compound machine 300, the compound machine initializing part 800 launches first. Then, the ROM monitor launching command stored in the head of the flashcard 407 is read, so that the ROM monitor 801 is launched. Then, the ROM monitor 801 performs initialization of hardware, diagnosing of hardware such as the controller board 400 in step S901. Then, the ROM monitor 801 launches the general OS 321 from the flash memory 404 in step S902.

Next, the program launching part 802 is called by the general OS 321, the launched program launching part 802 reads the configuration file from the flashcard 407 in step S903. Positions of the configuration file, the control service executable file, the application executable file in the flashcard 407 are obtained by referring to offsets in the header information.

According to the setting of the configuration file, the program launching part 802 launches each control service from the flashcard 407 in step S904. In addition, the program launching part 802 launches the application executable file 134 from the flashcard 407 in step S905.

Accordingly, as shown in FIG. 3, the new application 317 is executed on the compound machine 300. Therefore, if the user sets debug option in the new application 317, a value of a variable, an argument of a function, a return value of a function and the like are output with messages by printf clause and assert clause on a display device of the console PC 230 or on a display part of the operation panel 410, so that the user can debug the application.

As mentioned above, according to the first embodiment, the development server 100 generates the application executable file 134 of the new application 317 by linking the control service function library in the application development kit 131 with the object file 133. Thus, the new application 317 can be developed efficiently, in which the new application 317 performs interprocess communication by calling service functions provided by the control services.

The application development kit 131 of the first embodiment includes executable files of control services necessary for interprocess communication. Thus, debugging of the new application 317 can be performed without control services in the compound machine 300. That is, debugging of the new application 317 can be performed by using only control services in the application development kit 131. Thus, efficient debugging can be performed.

In addition, the application development kit 131 of the first embodiment includes control service executable files, and the development server 100 stores the application executable files 134 of the new application 317 and the control service executable file in the flashcard 407. Thus, the control services and the new applications 317 can be launched from the flashcard 407 at the time of launching the compound machine 300, so that debugging of the new application 317 can be easily performed.

In addition, by storing only the executable file of the new application developed according to a demand of a user in the flashcard 407 as shown in FIG. 9 and 10, the new application can be launched from the flashcard 407 in the compound machine that has been installed in a user site.

(Second Embodiment)

According to the first embodiment, the flashcard 407 stores the application executable file 134 generated by the development server 100 and the control service executable files in the flashcard 407, and the files are executed on the compound machine 300 from the flashcard 407 so that debugging is performed. According to the second embodiment, the debug environment is constructed via a network without the flashcard 407.

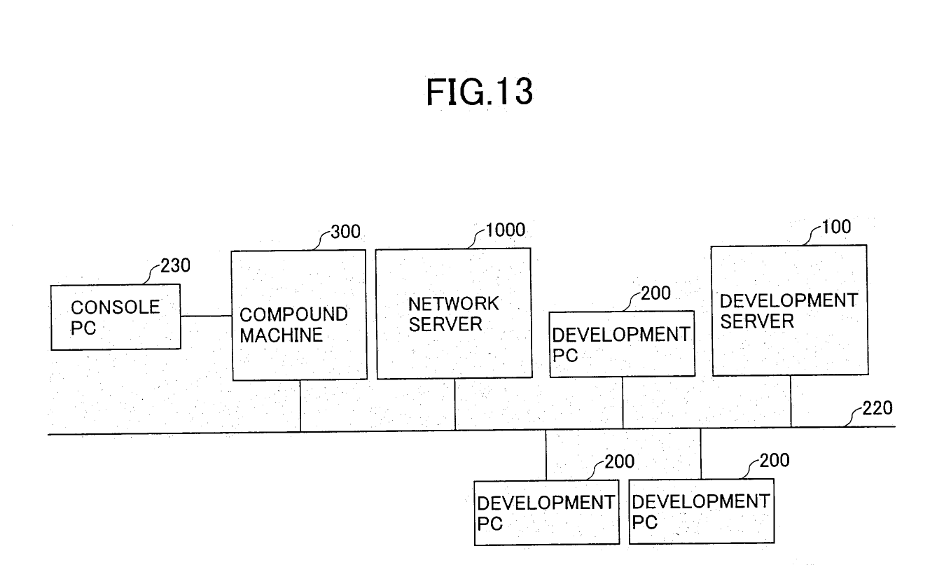

FIG. 13 is a block diagram showing a network configuration and the debugging environment including the development server 100, the development PC 200, a network server 1000 and the compound machine 300 according to the second embodiment. As shown in FIG. 13, in the second embodiment, the development server 100, a plurality of development PC 200 and the compound machine 300 are connected to the Ethernet 220 in the same way as the first embodiment. In addition, a network server 1000 is connected to the Ethernet 220 in the LAN environment. Configurations of the development server 100, the development PC 200, the compound machine 300 and the console PC 230 are the same as those of the first embodiment.

The network server 1000 mounts the new application 317 on the compound machine 300 by using NFS (network file system). Thus, the network server 1000 has the function of NFS.

In the following, a debugging method of the new application 317 by using the compound machine 300 and the network server 1000 will be described. The method for generating the new application 317 is the same as that of the first embodiment.

First, the user who debugs the application copies the application executable file 134 of the new application 317, the configuration file, and the control service executable files of the application development kit 131 to a predetermined directory in a hard disk of the network server 1000. In the same way as the first embodiment, the configuration file specifies the control services and the applications 330 to be executed in the compound machine 300. The configuration file is prepared by the user beforehand.

After setting network information and disk information, the network server 1000 is restarted, in which the network information includes MAC (Media Access Control) address of the network board of the compound machine 300, IP address of the compound machine 300, IP address of the network server and the like, and the disk information is used for exporting a directory that exists the application executable file 134 and that is mounted to the compound machine 300. If the general OS 321 is UNIX, the network information and disk information may be described as a shell script to be executed when launched.

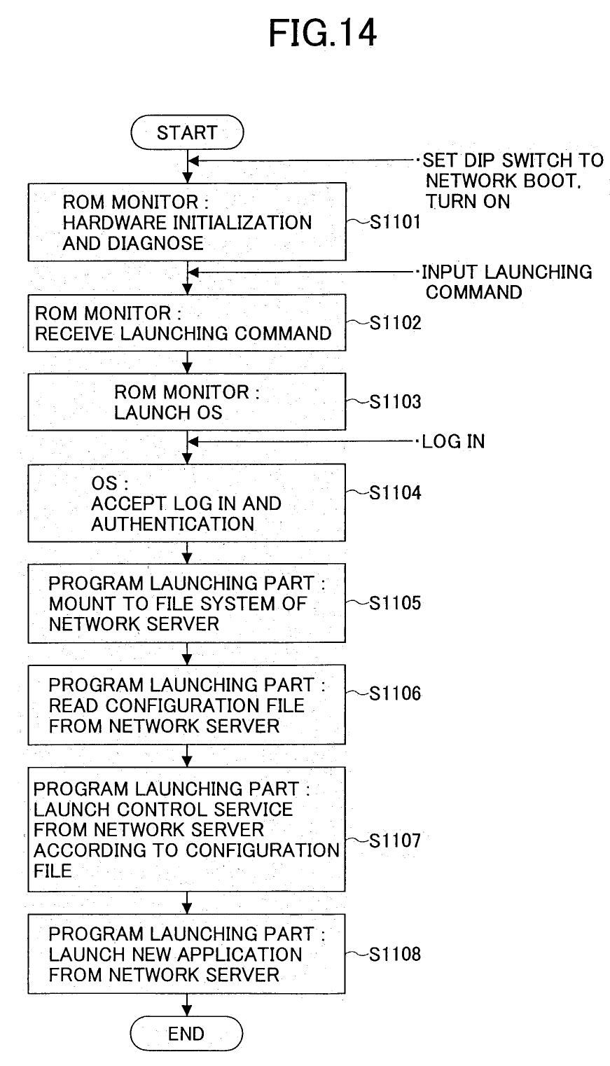

FIG. 14 is a flowchart showing a procedure for initialization at the time of network boot of the compound machine 300. The user sets a DIP switch of the compound machine 300 to the side of network boot, and turns on the compound machine 300. At this time, in the same way as the first embodiment of the compound machine 300, the ROM monitor 801 of the compound machine initialization part 800 initializes and diagnoses hardware in step S1101. Next, the ROM monitor 801 displays a screen for waiting for a launching command input. Then, the user inputs the launching command from the console PC 230. After the ROM monitor 801 receives the input launching command in step S1102, the ROM monitor 801 launches the general OS 321 in step S1103.

The general OS 321 displays a login input screen to the console PC 230, and waits for login input by the user. The user logs in to the compound machine 300 by inputting user name and a password from the console PC 230. Then, the general OS 321 performs a user authentication process in step S1104. When the user is valid, the general OS 321 launches the program launching part 802.

First, the program launching part 802 mounts an exported disk (or directory) of the network server 1000 in step S1105. If the general OS 321 is UNIX, the mount process can be performed by executing a shell script including a mount command at the time of executing the program launching part 802, in which the mount command is described in the disk information set by the network server 1000 and the mount command specifies a disk or a directory as the mount destination.

Next, the program launching part 802 reads the configuration file from the mounted disk of the network server 1000 in step S1106, and launches each control service from the disk (or directly) of the network server 1000 that is mounted by NFS according to the setting of the configuration file in step S1107. In addition, the program launching part 802 launches the application executable file 134 of the new application 317 from the disk (or directory) of the network server 1000 in step S1108.

Accordingly, as shown in FIG. 3, the new application 317 is executed on the compound machine 300. Therefore, if the user sets debug option in the new application 317, a value of a variable, an argument of a function, a return value of a function and the like are output with messages by printf clause and assert clause and the like on a display device of the console PC 230 or on a display part of the operation panel 410, so that the user can debug the application.

As mentioned above, according to the second embodiment, a disk or a directory of the network server 1000 that includes the application executable file 134 is mounted on the file system of the compound machine 300 by using NFS. Then, the control services and the new application 317 are launched, so that debugging of the new application is performed. Thus, it is not necessary to store the control services and the new application in a recording medium such as a flashcard 407. Therefore, debugging of the new application 317 can be performed more efficiently.

In addition, the network server 100 may includes only the executable file of the new application, such that the executable file of the new application is launched from the network server 100, and each control service is launched from a ROM in the compound machine.

The method of launching the new application from the network server 100 can be used not only for debugging but also for normal use of the compound machine by a user. For example, by connecting the compound machine 300 to a LAN that is connected to the Internet, a new application can be launched from a remote server that is connected to the Internet.

(Third Embodiment)

The application development kit 131 stores the control service executable file and does not include the application executable file 134 according to the first and second embodiments. On the other hand, the application development kit of the third embodiment includes the application executable file 134.

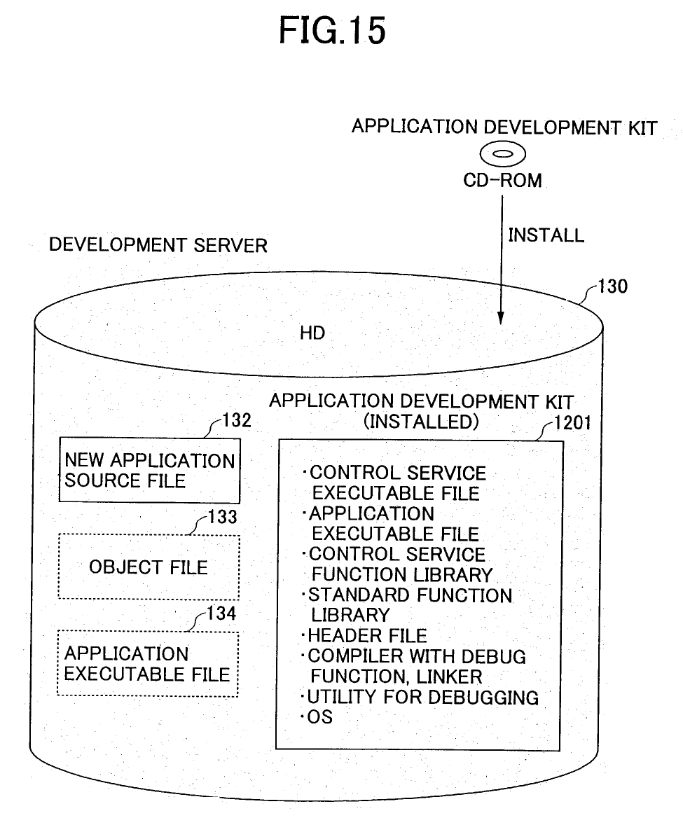

FIG. 15 is a figure for explaining files stored in the HD 130 of the development server 100 according to the third embodiment. Same as the development server 100 of the first embodiment, in the HD 130 of the development server 100 of the third embodiment, an application development kit 1201 is installed, and, the new application source file 132, the object file 133 of the application and the application executable file 134 are generated.

Like the application development kit 131 of the first embodiment, the application development kit 1201 is provided by a recording medium such as a CD-ROM or a flexible disk (FD). The application development kit 1201 can be installed to a computer from the recording medium. The application development kit 1201 is installed on the HD 130 of the development server 100. As shown in FIG. 15, the application development kit 1201 includes executable files of control services such as ECS 324 and MCS 325, the control service function library for each control service (for example, ECS function library, MCS function library), application executable files such as the copy application 312 and the printer application 311, the standard function library including C language standard functions such as strcpy and memcpy, a header file including function declarations and message declarations commonly used for the applications and the control services, a program for the compiler 110, a program of the linker 120, a general OS program and utilities for debugging such as a debugger. That is, the application development kit 1201 of the third embodiment is different from the application development kit 131 of the first embodiment in that the application executable files for the applications 330 are included in the application development kit 1201.

Thus, when the new application 317 (application executable file 134) is stored in the flashcard 407, the application executable files in the application development kit 1201 are also stored in the flashcard 407 with the control service executable files and the configuration file.

When the new application 317 is copied to the hard disk of the network server 1000 via a network, which is the second embodiment, the application executable file in the application development kit 1201 is also copied to the hard disk of the network server 1000 with the control service executable files and the configuration file via a network. When debugging the application by performing network boot of the compound machine 300, after launching control services, the program launching part 802 of the compound machine initialization part 800 launches the application 330 from a hard disk of the network server that is mounted by NFS in step S1107 in FIG. 12.

In the third embodiment, applications are, for example, the printer application 311, the copy application 312, a scanner application 314, a fax application 313, a net file application 315 and the like. The new application 317 can be configured such that the new application 317 performs interprocess communication with one or more applications.

As mentioned above, the application development kit 1201 includes the executable file of the existing applications 330, and the flashcard 407 stores the executable files of the new application 317, the existing applications and the control services. Thus, the new application can be developed by using the application development kit 1201 even when the new application 317 performs a function by using the existing application 330 as well as interprocess communication with the control services. In addition, the compound machine 300 can read and launch the executable files of the new application 317, the existing applications and the control services from a directory of the network server 1000 that is mounted by NFS. Therefore, the new application 317 can be developed efficiently.

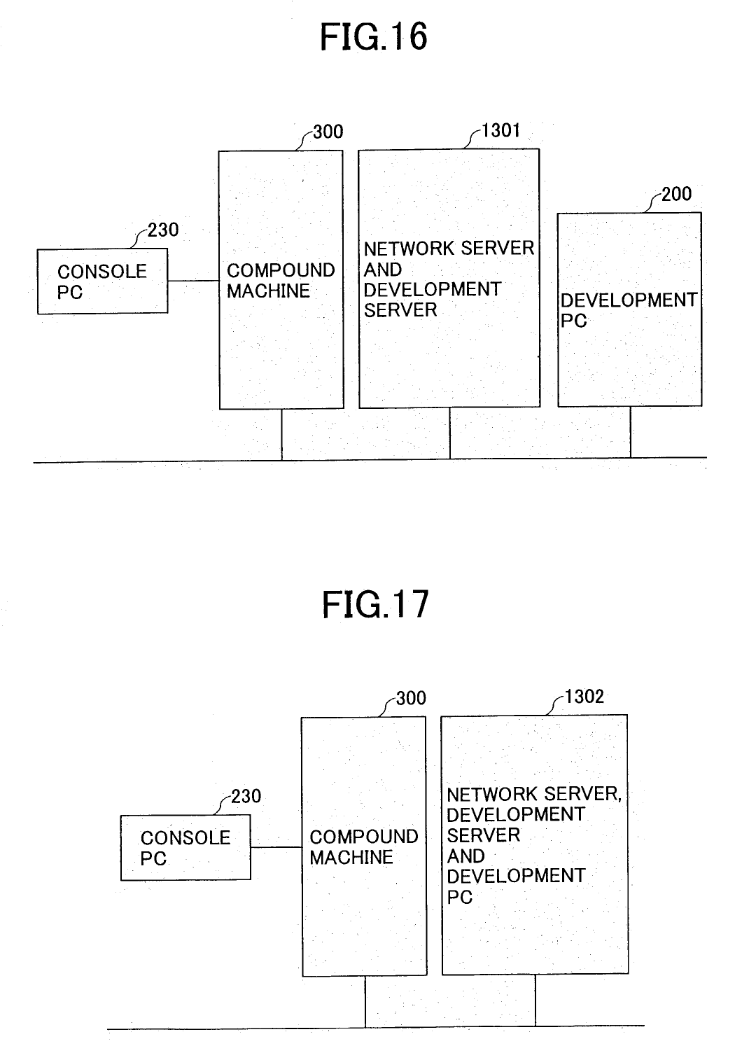

In the first to third embodiments, although the development server 100, the development PC 200 and the network server 1000 are provided separately, a computer 1301 can include functions of the network server 1000 and the development server as shown in FIG. 16. In addition, as shown in FIG. 17, the network server, the development server and the development PC can be formed by a computer 1302.

According to the present invention, a method for generating a new application used in an image forming apparatus is provided, in which the image forming apparatus includes hardware resources used for image formation, an application for performing processes on image formation, and a control service that exists between the application and the hardware resources, wherein interprocess communication is performed between the control service and the new application, and the method includes: a compile step of compiling a source file in which source code of the new application is described so as to generate an object file; and a link step of linking the object file with a service function library that includes service functions provided by the control service so as to generate an executable program of the new application. According to this method, the new application can be developed efficiently.

The method may further include a recording step of storing the executable program of the new application in a launching recording medium or in an installing recording medium. Accordingly, debugging becomes easy. And, the new application can be installed in the image forming apparatus from the installing recording medium.

In the method, the service function library is recorded in an application development recording medium that includes data or programs necessary for application development, and the application development recording medium further includes an executable program of the control service, the method further comprising: a recording step of storing the executable program of the new application and the executable program of the control service in a launching recording medium or in an installing recording medium.

Accordingly, debugging becomes easy since the executable programs can be launched from the launching recording medium. And, the new application and the control service can be installed in the image forming apparatus from the installing recording medium.

In the method, the application development recording medium further includes an executable program of the application, and the executable program of the application is further recorded in the launching recording medium or in the installing recording medium. According to this method, the new application can be developed by using the application development kit even when the new application performs a function by using the existing application. Thus, the new application can be developed efficiently.

In the method, the application development recording medium may further include a header file including message declarations and function declarations used commonly for the application and the control service; and the object file is generated on the basis of the source file and the header file in the compile step. Accordingly, the header file can be used even when there are message declarations and function declarations common to the control service and the new application. Thus, the new application can be developed efficiently.

According to the present invention, a method for launching a new application used in an image forming apparatus is also provided, in which the image forming apparatus includes hardware resources used for image formation, an application for performing processes on image formation, and a control service that exists between the application and the hardware resources, wherein interprocess communication is performed between the control service and the new application, the method includes: a program launching step of reading an executable program of the control service and an executable program of the new application from a launching recording medium that stores the executable programs, and launching the executable programs in the image forming apparatus, at the time when the image forming apparatus is launched.

According to this method, debugging of a new application can be performed efficiently. In addition, the new application can be provided to users speedily.

According to the present invention, a method is provided, in which the method include: a step of reading an executable program of the new application from a launching recording medium that stores the executable program, and launching the executable program in the image forming apparatus; and a step of reading an executable program of the control service from a memory in the image forming apparatus that stores the executable program of the control service, and launching the executable program of the control service in the image forming apparatus, at the time when the image forming apparatus is launched.

According to this method, debugging of a new application can be performed efficiently. In addition, the new application can be provided to users speedily.

In the method, the launching recording medium may further include an executable program of the application; and the executable program of the application is further read from the launching recording medium and is executed in the image forming apparatus. According to this method, the new application can be developed even when the new application performs a function by using an existing application without launching the existing application from a ROM of the image forming apparatus. Thus, the new application can be developed efficiently.

According to the present invention, a method is provided that includes: a connecting step of mounting a file system on a network storing an executable program of the new application to a file system in the image forming apparatus via the network at the time when the image forming apparatus is launched; and an application launching step of launching the new application from the file system on the network.

According to this method, it is not necessary to store a developed new application in a launching recording medium. Thus, after generating the new application, debugging of the new application can be performed efficiently. In addition, the new application can be launched from a remote server.

The method may further include: a service layer launching step of launching the control service from the file system on the network, or a service layer launching step of launching the control service from a memory in the image forming apparatus. Thus, debugging of the new application can be performed efficiently.

In the method, the file system on the network further includes an executable program of the application, and the executable program of the application is further launched from the file system on the network in the application launching step.

In addition, according to the present invention, a computer program for causing a computer to generate a new application by using the above-mentioned method for generating the new application can be provided. The computer program includes a compile program code means and a link program code means.

In addition, according to the present invention, an executable program generated by the above method for generating a new application used in an image forming apparatus can be provided. In addition, computer readable recording mediums storing the above-mentioned programs can be provided. In addition, according to the present invention, an image forming apparatus including the executable program can be obtained.

In addition, an application development recording medium used for developing a new application used in an image forming apparatus can be provided, in which the application development recording medium includes: a service function library including service functions provided by the control service; and an application generation program for causing a computer to generate an executable program of the new application from a source file in which source code of the new application is described. According to this recording medium, a new application can be developed efficiently.

The application development recording medium may further include a header file in which message declarations and function declarations are described, wherein the header file is used when the executable program of the new application is generated, or may include an executable program of the control service or an executable program of the application. The header file can be used so that the new application can be developed efficiently.

The present invention for developing and launching a new application for the image forming apparatus can be also applied to a general information processing apparatus that includes hardware resources, an application for providing a user service by using the hardware resources, and a control service that exists between the application and the hardware resources, wherein interprocess communication is performed between the control service and the new application.

According to the present invention, an application that operates on an image forming apparatus or on an information processing apparatus in which many processes are executed can be developed efficiently. In addition, the developed application can be verified accurately and efficiently.

The present invention is not limited to the specifically disclosed embodiments, and variations and modifications may be made without departing from the scope of the present invention.

What is claimed is:

1. A method for generating a new application used in an image forming apparatus, said image forming apparatus comprising hardware resources used for image formation, an application for performing processes on image formation, and a control service that exists between said application and said hardware resources, wherein interprocess communication is performed between said control service and said new application, said method comprising:
a compile step of compiling a source file in which source code of said new application is described so as to generate an object file; and
a link step of linking said object file with a service function library that includes service functions provided by said control service so as to generate an executable program of said new application.

2. The method as claimed in claim 1, said method further comprising a recording step of storing said executable program of said new application in a launching recording medium or in an installing recording medium.

3. The method as claimed in claim 1, wherein said service function library is recorded in an application development recording medium that includes data or programs necessary for application development, and said application development recording medium further includes an executable program of said control service, said method further comprising:
a recording step of storing said executable program of said new application and said executable program of said control service in a launching recording medium or in an installing recording medium.

4. The method as claimed in claim 3, wherein said application development recording medium further includes an executable program of said application, and said executable program of said application is further recorded in said launching recording medium or in-said installing recording medium.

5. The method as claimed in claim 3, wherein said application development recording medium further includes a header file including message declarations and function declarations used commonly for said application and said control service; and said object file is generated on the basis of said source file and said header file in said compile step.

6. A method for launching a new application used in an image forming apparatus, said image forming apparatus comprising hardware resources used for image formation, an application for performing processes on image formation, and a control service that exists between said application and said hardware resources, wherein interprocess communication is performed between said control service and said new application, said method comprising:
a program launching step of reading an executable program of said control service and an executable program of said new application from a launching recording medium that stores said executable programs, and launching said executable programs in said image forming apparatus, at the time when said image forming apparatus is launched.

7. A method for launching a new application used in an image forming apparatus, said image forming apparatus comprising hardware resources used for image formation, an application for performing processes on image formation, and a control service that exists between said application and said hardware resources, wherein interprocess communication is performed between said control service and said new application, said method comprising:
a step of reading an executable program of said new application from a launching recording medium that stores said executable program, and launching said executable program in said image forming apparatus; and
a step of reading an executable program of said control service from a memory in said image forming apparatus that stores said executable program of said control service, and launching said executable program of said control service in said image forming apparatus, at the time when the image forming apparatus is launched.

8. The method as claimed in claim 6, wherein said launching recording medium further includes an executable program of said application; and said executable program of said application is further read from said launching recording medium and is executed in said image forming apparatus.

9. A method for launching a new application used in an image forming apparatus, said image forming apparatus comprising hardware resources used for image formation, an application for performing processes on image formation, and a control service that exists between said application and said hardware resources, wherein interprocess communication is performed between said control service and said new application, said method comprising:
a connecting step of mounting a file system on a network storing an executable program of said new application to a file system in said image forming apparatus via said network at the time when said image forming apparatus is launched; and
an application launching step of launching said new application from said file system on said network.

10. The method as claimed in claim 9, said method further comprising:
a service layer launching step of launching said control service from said file system on said network.

11. The method as claimed in claim 9, said method further comprising:
a service layer launching step of launching said control service from a memory in said image forming apparatus.

12. The method as claimed in claim 9, wherein said file system on said network further includes an executable program of said application, and said executable program of said application is further launched from said file system on said network in said application launching step.

13. A computer program for causing a computer to generate a new application used in an image forming apparatus, said image forming apparatus comprising hardware resources used for image formation, an application for performing processes on image formation, and a control service that exists between said application and said hardware resources, wherein interprocess communication is performed between said control service and said new application, said computer program comprising;
a compile program code means for compiling a source file in which source code of said new application is described so as to generate an object file; and
a link program code means for linking said object file with a service function library that includes service functions provided by said control service so as to generate an executable program of said new application.

14. The computer program as claimed in claim 13, said computer program further comprising a recording program code means of storing said executable program of said new application in a launching recording medium or in an installing recording medium.

15. The computer program as claimed in claim 13, wherein said service function library is recorded in an application development recording medium that includes data or programs necessary for application development, and said application development recording medium further includes a header file including message declarations and function declarations used commonly for said application and said control service; and said object file is generated on the basis of said source file and said header file by said compile program code means.

16. An executable program generated by a method for generating a new application used in an image forming apparatus,.said image forming apparatus comprising hardware resources used for image formation, an application for performing processes on image formation, and a control service that exists between said application and said hardware resources, wherein interprocess communication is performed between said control service and said new application, said method comprising;
a compile step of compiling a source file in which source code of said new application is described so as to generate an object file; and
a link step of linking said object file with a service function library that includes service functions provided by said control service so as to generate said executable program of said new application.

17. A computer readable recording medium storing program code for causing a computer to generate a new application used in an image forming apparatus, said image forming apparatus comprising hardware resources used for image formation, an application for performing processes on image formation, and a control service that exists between said application and said hardware resources, wherein interprocess communication is performed between said control service and said new application, said computer readable recording medium comprising;
a compile program code means for compiling a source file in which source code of said new application is described so as to generate an object file; and
a link program code means for linking said object file with a service function library that includes service functions provided by said control service so as to generate-an executable program of said new application.

18. A computer readable medium storing executable program code generated by a method for generating a new application used in an image forming apparatus, said image forming apparatus comprising hardware resources used for image formation, an application for performing processes on image formation, and a control service that exists between said application and said hardware resources, wherein interprocess communication is performed between said control service and said new application, said method comprising;
a compile step of compiling a source file in which source code of said new application is described so as to generate an object file; and
a link step of linking said object file with a service function library that includes service functions provided by said control service so as to generate an executable program of said new application.

19. An image forming apparatus including an executable program generated by a method for generating a new application used in said image forming apparatus, said image forming apparatus comprising hardware resources used for image formation, an application for performing processes on image formation, and a control service that exists between said application and said hardware resources, wherein interprocess communication is performed between said control service and said new application, said method comprising;
a compile step of compiling a source file in which source code of said new application is described so as to generate an object file; and
a link step of linking said object file with a service function library that includes service functions provided by said control service so as to generate an executable program of said new application.

20. An application development recording medium used for developing a new application used in an image forming apparatus, said image forming apparatus comprising hardware resources used for image formation, an application for performing processes on image formation, and a control service that exists between said application and said hardware resources, wherein interprocess communication is performed between said control service and said new application, said application development recording medium comprising;
a service function library including service functions provided by said control service; and
an application generation program for causing a computer to generate an executable program of said new application from a source file in which source code of said new application is described.

21. The application development recording medium as claimed in claim 20, wherein said application generation program causes said computer to perform:
a compile step of compiling said source file so as to generate an object file; and
a link step of linking said object file with said service function library so as to generate an executable program of said new application.

22. The application development recording medium as claimed in claim 20, said application development recording medium further includes a header file in which message declarations and function declarations are described wherein said header file is used when said executable program of said new application is generated.

23. The application development recording medium as claimed in claim 20, said application development recording medium further comprising an executable program of said control service.

24. The application development recording medium as claimed in claim 20, said application development recording medium further comprising an executable program of said application.

25. A method for generating a new application used in an information processing apparatus, said information processing apparatus comprising hardware resources, an application for providing a user service by using said hardware resources, and a control service that exists between said application and said hardware resources, wherein interprocess communication is performed between said control service and said new application, said method comprising;
a compile step of compiling a source file in which source code of said new application is described so as to generate an object file; and
a link step of linking said object file with a service function library that includes service functions provided by said control service so as to generate an executable program of said new application.

26. The method as claimed in claim 25, said method further comprising a recording step of storing said executable program of said new application in a launching recording medium or in an installing recording medium.

27. The method as claimed in claim 25, wherein said service function library is recorded in an application development recording medium that includes data or programs necessary for application development, and said application development recording medium further includes an executable program of said control service, said method further comprising:
a recording step of storing said executable program of said new application and said executable program of said control service in a launching recording medium or in an installing recording medium.

28. The method as claimed in claim 27, wherein said application development recording medium further includes an executable program of said application, and said executable program of said application is further recorded in said launching recording medium or in said installing recording medium.

29. The method as claimed in claim 27, wherein said application development recording medium further includes a header file including message declarations and function declarations used commonly for said application and said control service; and said object file is generated on the basis of said source file and said header file in said compile step.

30. A method for launching a new application used in an information processing apparatus, said information processing apparatus comprising hardware resources, an application for providing a user service by using said hardware resources, and a control service that exists between said application and said hardware resources, wherein interprocess communication is performed between said control service and said new application, said method comprising:
a program launching step of reading an executable program of said control service and an executable program of said new application from a launching recording medium that stores said executable programs, and launching said executable programs in said information processing apparatus, at the time when said information processing apparatus is launched.

31. A method for launching a new application used in an information processing apparatus, said information processing apparatus comprising hardware resources, an application for providing a user service by using said hardware resources, and a control service that exists between said application and said hardware resources, wherein interprocess communication is performed between said control service and said new application, said method comprising:
a step of reading an executable program of said new application from a launching recording medium that stores said executable program, and launching said executable program in said information processing apparatus; and
a step of reading an executable program of said control service from a memory in said information processing apparatus that stores said executable program of said control service, and launching said executable program of said control service in said information processing apparatus, at the time when the information processing apparatus is launched.

32. The method as claimed in claim 30, wherein said launching recording medium further includes an executable program of said application; and said executable program of said application is read from said launching recording medium and is executed in said information processing apparatus.

33. A method for launching a new application used in an information processing apparatus, said information processing apparatus comprising hardware resources, an application for providing a user service by using said hardware resources, and a control service that exists between said application and said hardware resources, wherein interprocess communication is performed between said control service and said new application, said method comprising:
a connecting step of mounting a file system on a network storing an executable program of said new application to a file system in said information processing apparatus via said network; and
an application launching step of launching said new application from said file system on said network.

34. The method as claimed in claim 33, said method further comprising:
a service layer launching step of launching said control service from said file system on said network.

35. The method as claimed in claim 33, said method further comprising:
a service layer launching step of launching said control service from a memory in said information processing apparatus.

36. The method as claimed in claim 33, wherein said file system in said network further includes an executable program of said application, and said executable program of said application is further launched from said file system on said network in said application launching step.

37. A computer program for causing a computer to generate a new application used in an information processing apparatus, said information processing apparatus comprising hardware resources, an application for providing a user service by using said hardware resources, and a control service that exists between said application and said hardware resources, wherein interprocess communication is performed between said control service and said new application, said computer program comprising;
a compile program code means for compiling a source file in which source code of said new application is described so as to generate an object file; and
a link program code means for linking said object file with a service function library that includes service functions provided by said control service so as to generate an executable program of said new application.

38. The computer program as claimed in claim 37, said computer program further comprising a recording program code means of storing said executable program of said new application in a launching recording medium or in an installing recording medium.

39. The computer program as claimed in claim 37, wherein said service function library is recorded in an application development recording medium that includes data or programs necessary for application development, and said application development recording medium further includes a header file including message declarations and function declarations used commonly for said application and said control service; and said object file is generated on the basis of said source file and said header file by said compile program code means.

40. An executable program generated by a method for generating a new application used in an information processing apparatus, said information processing apparatus comprising hardware resources, an application for providing a user service by using said hardware resources, and a control service that exists between said application and said hardware resources, wherein interprocess communication is performed between said control service and said new application, said method comprising;
a compile step of compiling a source file in which source code of said new application is described so as to generate an object file; and
a link step of linking said object file with a service function library that includes service functions provided by said control service so as to generate an executable program of said new application.

41. A computer readable recording medium storing program code for causing a computer to generate a new application used in an information processing apparatus, said information processing apparatus comprising hardware resources, an application for providing a user service by using said hardware resources, and a control service that exists between said application and said hardware resources, wherein interprocess communication is performed between said control service and said new application, said computer readable recording medium comprising;
a compile program code means for compiling a source file in which source code of said new application is described so as to generate an object file; and
a link program code means for linking said object file with a service function library that includes service functions provided by said control service so as to generate an executable program of said new application.

42. A computer readable medium storing executable program code generated by a method for generating a new application used in an information processing apparatus, said information processing apparatus comprising hardware resources, an application for providing a user service by using said hardware resources, and a control service that exists between said application and said hardware resources, wherein interprocess communication is performed between said control service and said new application, said method comprising;
a compile step of compiling a source file in which source code of said new application is described so as to generate an object file; and
a link step of linking said object file with a service function library that includes service functions provided by said control service so as to generate an executable program of said new application.

43. An information processing apparatus including an executable program generated by a method for generating a new application used in said information processing apparatus, said information processing apparatus comprising hardware resources, an application for providing a user service by using said hardware resources, and a control service that exists between said application and said hardware resources, wherein interprocess communication is performed between said control service and said new application, said method comprising;
a compile step of compiling a source file in which source code of said new application is described so as to generate an object file; and
a link step of linking said object file with a service function library that includes service functions provided by said control service so as to generate an executable program of said new application.

44. An application development recording medium used for developing a new application used in an information processing apparatus, said information processing apparatus comprising hardware resources, an application for providing a user service by using said hardware resources, and a control service that exists between said application and said hardware resources, wherein interprocess communication is performed between said control service and said new application, said application development recording medium comprising;
a service function library including service functions provided by said control service; and
an application generation program for causing a computer to generate an executable program of said new application from a source file in which source code of said new application is described

45. The application development recording medium as claimed in claim 20, wherein said application generation program causes said computer to perform:
a compile step of compiling said source file so as to generate an object file; and
a link step of linking said object file with said service function library so as to generate an executable program of said new application.

46. The application development recording medium as claimed in claim 44, said application development recording medium further includes a header file in which message declarations and function declarations are described, wherein said header file is used when said executable program of said new application is generated.

47. The application development recording medium as claimed in claim 44, said application development recording medium further comprising an executable program of said control service.

48. The application development recording medium as claimed in claim 44, said application development recording medium further comprising an executable program of said application.
